(19) United States
(12) Patent Application Publication
(10) Pub. No.: US 2026/0131303 A1
(43) Pub. Date: May 14, 2026

(54) CHLORINE-NITROGEN CO-COORDINATED SINGLE-ATOM ZIRCONIUM ADSORBENT AND USE THEREOF IN SELECTIVE FLUORIDE REMOVAL FROM HIGH-SALINITY WASTEWATER

(71) Applicants: Nanjing Institute of Environmental Sciences, MEE, Nanjing (CN); Nanjing Forestry University, Nanjing (CN); Nanjing Lingqingyue Environmental Technology Co., LTD, Nanjing (CN); Nanjing Huachuang Environmental Technology Research Institute Co., LTD, Nanjing (CN)

(72) Inventors: Changqing Zhu, Nanjing (CN); Na Wang, Nanjing (CN); Chen Ling, Nanjing (CN); Zhiyong Zhang, Nanjing (CN); Ying Liang, Nanjing (CN); Baoju Li, Nanjing (CN); Mali Shi, Nanjing (CN)

(21) Appl. No.: 19/433,078

(22) Filed: Dec. 26, 2025

(30) Foreign Application Priority Data
Jul. 7, 2025 (CN) 202510926813.1

(51) Int. Cl. B01J 20/02; B01J 20/30; B01J 20/32; C02F 1/28; C02F 101/14; C02F 103/34

(52) U.S. Cl. CPC B01J 20/0211; B01J 20/3021; B01J 20/3078; B01J 20/3204; B01J 20/3236; C02F 1/281; C02F 2101/14; C02F 2103/346

(57) ABSTRACT

The present disclosure discloses a chlorine-nitrogen co-coordinated single-atom zirconium adsorbent and use thereof in selective fluoride removal from high-salinity wastewater, belonging to the technol field of fluoride-containing wastewater treatment. The present disclosure involves the self-assembly of melamine and cyanuric acid to obtain a supermolecule, followed by ball milling of the supermolecule with zirconium chloride and subsequent pyrolysis twice to obtain the chlorine-nitrogen co-coordinated single-atom zirconium adsorbent. The adsorbent achieves selective capture of low concentrations of fluoride ions in the high-salinity wastewater by exerting strong electrostatic repulsion on oxygen-containing acid radicals by negatively charged nitrogen ligands and exerting strong coordination on fluoride ions by positively charged zirconium atoms.

### TECHNICAL FIELD

The present disclosure belongs to the technical field of fluoride-containing wastewater treatment, and particularly relates to a chlorine-nitrogen co-coordinated single-atom zirconium adsorbent and use thereof in selective fluoride removal from high-salinity wastewater.

### BACKGROUND

Fluorine is widely applied in industrial production processes such as glass manufacturing, electroplating and etching, electronic processing, and pesticide synthesis, meanwhile producing a large amount of fluorine-containing waste liquid. In actual fluoride-containing wastewater, fluoride ions (F⁻) often coexist with high concentrations of inorganic salt anions such as nitrates, sulfates, and chloride ions. Currently, methods for treating the fluoride-containing wastewater mainly include chemical precipitation, coagulation/flocculation, etc. The chemical precipitation converts high concentrations of F⁻ into calcium fluoride precipitates by dosing calcium salts. However, as limited by a calcium fluoride solubility product (Kₛₚ=3.9×10⁻¹¹), this method can only reduce the F⁻ concentration to about 10 mg/L. Although the coagulation/flocculation can further remove F⁻, the high concentrations of inorganic salt anions co-existed in the water can seriously interfere with effects such as electrostatic attraction, complexation, and entrapment of F⁻ by coagulants/flocculators through a common ion effect. Excessive amount of the agent is required to be dosed to reduce the F⁻ concentration to meet the requirements of GB 3838-2002 “Environmental quality standards for surface water”. Moreover, the method also faces application bottlenecks such as the large footprint of a floc sedimentation tank and the high fluoride-containing hazardous waste production. Therefore, there is an urgent need to develop efficient deep fluoride removal technology.

Currently reported deep fluoride removal technologies mainly include membrane separation, electrodialysis, ion exchange, and adsorption. Among them, the adsorption has attracted much attention due to its advantages such as simple operation and small footprint. A wide range of materials, such as activated alumina, magnetic iron oxides, layered double hydroxides, and metal-organic frameworks have been used for adsorptive removal of F⁻ from water. However, under the strong site competition interference of high concentrations of inorganic salt anions, the fluoride removal performance of most adsorbents is inhibited to varying degrees, exhibiting the defect of poor salt tolerance. For example, Jianguo Cai et al. have prepared a fluoride removal adsorbent by loading Li/Al layered double hydroxides with polystyrene anionic exchange resins. When the dosage of the adsorbent is 0.5 g/L and the F⁻ concentration is 20 mg/L, only adding 40 mg/L of SO₄²⁻ or PO₄³⁻ reduces the F⁻ adsorption capacity by approximately 67% and 71%, respectively (data comes from: Jianguo Cai, Yanyang Zhang, Bingcai Pan, Weiming Zhang, Lu Lv, Quanxing Zhang, Efficient defluoridation of water using reusable nanocrystalline layered double hydroxides impregnated polystyrene anion exchanger, Water Research, 2016, 102, 109-116). Based on the theory of soft and hard acids and bases, zirconium has strong coordination ability with F″, so zirconium-containing adsorbents have been developed in large quantities to enhance fluoride removal. However, currently, there are still two main problems in removing low concentrations of F⁻ from high-salinity wastewater with zirconium-containing adsorbents: (1) It has been reported that zirconium exists in the form of nanoparticles or larger dimensions in the adsorbent. Only zirconium atoms with exposed surfaces can be used for F⁻ removal. Most of the zirconium atoms are buried inside the particles and cannot play a role, resulting in a low zirconium atom utilization rate. (2) Relying solely on the high affinity of zirconium for F⁻ can only resist the interference of low-concentration inorganic salts, and it is still difficult to overcome the strong site competition effect of high-concentration inorganic salts. For example, when Bingcai Pan et al. use porous polymer-supported hydrated zirconium oxide nanoparticles to prepare an adsorbent for removing F⁻ (at an adsorbent dosage: 1.0 g/L, and a F⁻ concentration: 10 mg/L), 500 mg/L of each of Cl⁻, NO₃⁻, or SO₄²⁻ can reduce the adsorption capacity of F⁻ by more than 70% (data comes from: Bingcai Pan, Jingsheng Xu, Bing Wu, Zhigang Li, Xitong Liu, Enhanced removal of fluoride by polystyrene anion exchanger supported hydrous zirconium oxide nanoparticles, Environmental Science & Technology, 2013, 47, 9347-9354). Therefore, it has become an urgent problem to be solved how to design the structures of zirconium-containing adsorbents so that they can make full use of zirconium atoms and achieve selective fluoride removal from high-salinity wastewater.

### SUMMARY

A first technical problem to be solved by the present disclosure is to provide a method for preparing a chlorine-nitrogen co-coordinated single-atom zirconium adsorbent. This method involves double pyrolysis of a mixture of a melamine-cyanuric acid supermolecule and zirconium chloride. The second pyrolysis allows for further delamination of a carbon nitride support, thereby exposing more adsorption sites and increasing the fluoride removal capacity of the adsorbent compared to single pyrolysis. A second technical problem to be solved by the present disclosure is to provide a chlorine-nitrogen co-coordinated single-atom zirconium adsorbent with a large zirconium loading. A negatively charged nitrogen ligand in a single-atom zirconium site can exert strong electrostatic repulsion to inhibit the competitive adsorption of an oxygen-containing acid radical anion. At the same time, the chlorine-nitrogen co-coordinated structure can increase the positive electricity of zirconium to increase the binding strength of zirconium to F⁻. A third technical problem to be solved by the present disclosure is to provide use of a chlorine-nitrogen co-coordinated single-atom zirconium adsorbent in removal of low concentrations of F⁻ from high-salinity wastewater.

To solve the aforementioned technical problems, the technical solutions adopted by the present disclosure are as follows.

A method for preparing a chlorine-nitrogen co-coordinated single-atom zirconium adsorbent includes the following steps:
1) dissolving melamine and cyanuric acid respectively in hot water, mixing the two resulting solutions, then continually heating and stirring to carry out a self-assembly reaction, filtering by suction and oven-drying to obtain a supermolecule; and
2) ball-milling the supermolecule obtained in the step 1) with zirconium chloride under mixing, placing the resulting mixed powder into a tube furnace and subjecting to first pyrolysis under protection with an inert gas, cooling, then placing the resulting powder into the tube furnace again and subjecting to second pyrolysis under protection with an inert gas to obtain the chlorine-nitrogen co-coordinated single-atom zirconium adsorbent.

Further, in the step 1), a molar ratio of melamine to cyanuric acid is 1:1; a concentration of a melamine or cyanuric acid solution is 0.1-5 mol/L; a temperature of the hot water for dissolving melamine or cyanuric acid is 80-100° C.; a heating temperature when the self-assembly is performed after the melamine solution and the cyanuric acid solution are mixed is 80-100° C., and a time for the stirring is 1-4 h.

Further, in the step 2), a mass ratio of the supermolecule to zirconium chloride is 1:0.2-1:1.2; a rotation speed for ball milling the supermolecule with zirconium chloride under stirring is 400-800 r/min, and a time for the ball milling is 10-60 min.

Further, in the step 2), during the first pyrolysis, a protecting gas is nitrogen or argon, a heating rate is 1-10° C./min, a temperature of the pyrolysis is 500-800° C., and a duration of the pyrolysis is 1-4 h.

Further, in the step 2), during the second pyrolysis, a protecting gas is nitrogen or argon, a heating rate is 5-10° C./min, a temperature of the pyrolysis is 500-800° C., and a duration of the pyrolysis is 1-2 h.

Further, a chlorine-nitrogen co-coordinated single-atom zirconium adsorbent is prepared by the method for preparing a chlorine-nitrogen co-coordinated single-atom zirconium adsorbent.

Further, use of the chlorine-nitrogen co-coordinated single-atom zirconium adsorbent in the removal of low concentrations of F⁻ in high-salinity wastewater, is provided.

Further, a concentration of F⁻ is not higher than 10 mg/L.

Further, when the concentration of F⁻ is not higher than 10 mg/L, a dosage of the adsorbent in the wastewater is 0.25-0.50 g/L.

Compared with the prior art, the present disclosure has the following advantages:
(1) There are no reports on the chlorine-nitrogen co-coordinated single-atom zirconium adsorbent and use thereof in fluoride removal in the prior art. The adsorbent of the present disclosure can not only utilize the unsaturated coordination structure of zirconium atoms to give full play to its specific adsorption capacity for F⁻, but also the presence of chlorine and nitrogen ligands, especially axial chlorine ligands, increases the positive electricity of zirconium and can increase the binding strength of single-atom zirconium sites to F⁻. Therefore, it is applicable for selective fluoride removal in high-salinity wastewater.
(2) In commercially available or literature-reported zirconium-based adsorbents, zirconium mainly exists in the form of nanoparticles or larger dimensions. Only zirconium atoms on the surface of the particles are actually used for fluoride removal. Most of the zirconium is buried inside the particles and cannot come into contact with F, resulting in a low zirconium utilization rate. In the adsorbent prepared by the present disclosure, zirconium is dispersed in the form of single atoms on a two-dimensional carbon nitride support. All zirconium atoms can be exposed as F⁻ adsorption sites, theoretically achieving a zirconium atom utilization rate of 100%. Therefore, the atom economy of the adsorbent can be significantly improved, and the preparation cost is reduced.
(3) Compared with conventional adsorbents, which significantly reduce the fluoride removal efficiency when removing low concentrations of F⁻ from high-salinity wastewater due to a site competition effect, a chlorine-nitrogen co-coordinated single-atom zirconium site in the adsorbent of the present disclosure has unique selectivity for F⁻. In this site, zirconium is positively charged, while chlorine and nitrogen are negatively charged. When applied to water, chloride ions firstly ionize and enter the water, thereby exposing single-atom Zr—N sites. When oxygen-containing acid radicals such as sulfates and nitrates approach the Zr—N sites, the negatively charged N ligands exert strong electrostatic repulsion onto the negatively charged O in the oxygen-containing acid radicals, making it difficult for the oxygen-containing acid radicals to bind stably with Zr and thus being adsorbed. When chloride ions or anions such as F⁻ that do not contain oxygen and contain only one atom simultaneously approach the Zr—N sites, the stronger coordination affinity of Zr for F⁻ leads to the preferential adsorption of F⁻. Therefore, the single-atom zirconium adsorbent prepared by the present disclosure can selectively adsorb low concentrations of F⁻ in the high-salinity wastewater, and can still achieve efficient removal of F⁻ even when the concentration of co-existed inorganic salt anions is as high as 100 mmol/L (190 times the concentration of F⁻ of 10 mg/L).
(4) The carbon nitride support prepared by the present disclosure has intrinsic nanopores and abundant nitrogen ligands, which are applicable for anchoring of zirconium atoms at a high loading. The optimal single-atom zirconium adsorbent as prepared has a zirconium loading of up to 35.66 wt %, which makes its fluoride removal capacity 5.6 times and 21.5 times those of the commercially available anion exchange resin D213 and zirconium dioxide nanoparticles, respectively. In practical applications, it can significantly reduce the dosage of the adsorbent and reduce the volume of the adsorption device.

### BRIEF DESCRIPTION OF THE DRAWINGS

FIG. 1 is a spherical aberration-corrected scanning transmission electron microscope image of a CNZr₂-6 adsorbent prepared in Example 1 of the present application;

FIG. 2 is a high-angle annular dark-field (HAADF) scanning transmission electron microscope image and elemental face scanning diagram of the CNZr₂-6 adsorbent prepared in Example 1 of the present application;

FIG. 3 is a wavelet transform image of an X-ray absorption fine structure of the CNZr₂-6 adsorbent prepared in Example 1 of the present application;

FIG. 4 is a comparison chart of the fluoride removal performances of the CNZr₁-6 adsorbent and the CNZr₂-6 adsorbent prepared in Example 1 of the present application.

FIG. 5 is a comparison chart of the fluoride removal performances of the adsorbents synthesized from three different carbon nitride precursors in Example 1 and Comparative Examples 1-2 of the present application.

FIG. 6 is a comparison chart of the fluoride removal performances of the adsorbents synthesized under different dosages of zirconium chloride in Example 2 of the present application;

FIG. 7 is a comparison chart of the fluoride removal performances of the adsorbents synthesized at different pyrolysis temperatures in Example 3 of the present application;

FIG. 8 is a diagram showing the effect of different concentrations and types of inorganic salt anions on the fluoride removal performance of the CNZr₂-6 adsorbent prepared in Example 1 of the present application; where panel (a) shows an adsorbent dosage of 0.25 g/L; panel (b) shows an adsorbent dosage of 0.35 g/L; and panel (c) shows an adsorbent dosage of 0.50 g/L; and

FIG. 9 is a comparison chart of the fluoride removal performances of a PAMD resin, a D213 resin and a ZrO₂ nanoparticle in Comparative Example 3 of the present application.

### DETAILED DESCRIPTION OF THE EMBODIMENTS

The present disclosure will be further illustrated hereafter in connection with specific embodiments. These embodiments are implemented based on the technical solutions of the present disclosure. It should be understood that, the following examples are only intended to illustrate the present disclosure, rather than limiting the scope of the present disclosure.

The melamine, cyanuric acid, zirconium chloride, and fluoroboric acid used in the following examples are all analytical pure and purchased from Aladdin Biochemical Technology Co., Ltd.; sodium fluoride, sodium hydroxide, sodium chloride, sodium citrate dihydrate, acetic acid, nitric acid, and sulfuric acid are all analytical pure and purchased from Sinopharm Chemical Reagent Co., Ltd.; hydrochloric acid is analytical pure and purchased from Nanjing Chemical Reagent Co., Ltd.; PAMD resin is a triethylenetetramine-grafted acrylic resin disclosed in patent number ZL 201310108031.4; D213 resin is a quaternary ammonium salt modified styrene resin purchased from Tianjin Yunkai Resin Technology Co., Ltd.; and ZrO₂ nanoparticle s have a particle size of 20-40 nm and a purity of 99 wt %, and are purchased from Jiangsu XFNANO Materials Tech Co., Ltd.

In the following examples, operational steps of heat digestion are: 5 mg of an adsorbent is weighed into a polytetrafluoroethylene digestion tube, and sequentially added with 2 mL of nitric acid, 2 mL of sulfuric acid, and 2 mL of fluoroboric acid, and then a digestion procedure is started. Firstly, pre-digestion is conducted at 60° C. for 30 min, then the temperature is increased to 160° C. for digestion for 30 min, and finally the temperature is increased to 300° C. for digestion for 45 min. After cooling to room temperature, the volume is made up to 100 mL. The zirconium content in the digestion solution is determined by inductively coupled plasma emission spectrometry.

In the following examples, a method for testing a F⁻ concentration is as follows: 20 mL of the solution after adsorption equilibrium is taken, and filtered with a 0.22 μm filter head. The filtrate is added with 10 mL of the total ionic strength adjustment buffer (TISAB), then diluted to 50 mL, and subsequently transferred into a 100 mL polyethylene beaker. The F⁻ concentration in the solution is measured using a fluoride ion meter.

A method for formulating a total ionic strength adjustment buffer (TISAB) is as follows: 58 g of sodium chloride, 10 g of sodium citrate dihydrate, and 50 mL of acetic acid are weighed or measured into 500 mL of water, mixed well, then added with 135 mL of a 5 mol/L sodium hydroxide solution to adjust the pH of the solution to 5.2, and added with water to dilute to 1 L.

### Example 1

A method for preparing a chlorine-nitrogen co-coordinated single-atom zirconium adsorbent included the following steps:

### 1) Supermolecule Synthesis

0.05 mol of melamine was added into 50 mL of ultrapure water and heated with stirring at 80° C. until completely dissolved to obtain a solution A. Another 0.05 mol of cyanuric acid was taken and added into 50 mL of ultrapure water and heated with stirring at 80° C. until completely dissolved to obtain a solution B. The solution B was poured into the solution A and continually heated with stirring at 80° C. for 4 h. After the melamine and the cyanuric acid had been self-assembled, separation by suction filtration was conducted and oven-drying was conducted in an oven at 60° C. to obtain a supermolecule.

### 2) Synthesis of Chlorine-Nitrogen Co-Coordinated Single-Atom Zirconium Adsorbent

2 g of the supermolecule was mixed with 6 mmol of ZrCl₄ and ball-milled at a rotation speed of 550 r/min for 15 min. The resulting mixture was placed into a tube furnace, heated to 600° C. at a rate of 5° C./min under a nitrogen atmosphere and held at this temperature for 2 h to obtain a material from first pyrolysis (named as CNZr₁-6). The material from the first pyrolysis was placed into a tube furnace, heated to 600° C. at a rate of 10° C./min under a nitrogen atmosphere and held at this temperature for 1 h to obtain a chlorine-nitrogen co-coordinated single-atom zirconium adsorbent (named as CNZr₂-6) after second pyrolysis.

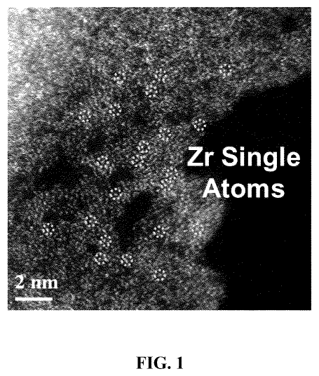

FIG. 1 was a spherical aberration-corrected scanning transmission electron microscope image of the CNZr₂-6 adsorbent, which showed that high-density zirconium single atoms were dispersed on a porous carbon nitride support.

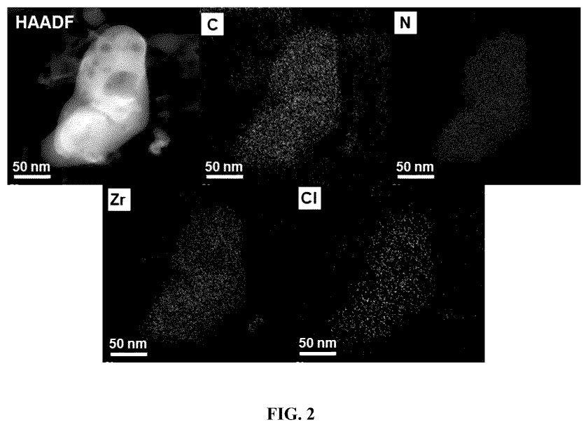

FIG. 2 was a high-angle annular dark-field (HAADF) scanning transmission electron microscope image and elemental face scanning diagram of the CNZr₂-6 adsorbent, which showed that the adsorbent contained C, N, Zr, and Cl elements.

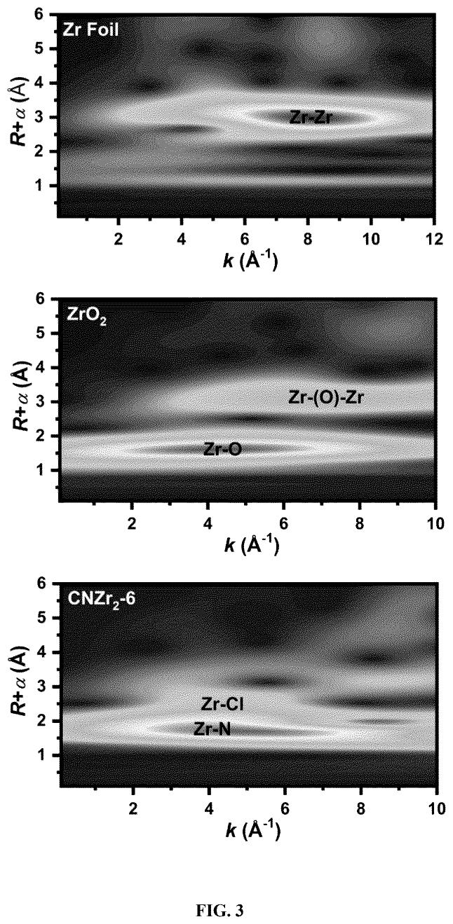

FIG. 3 was a wavelet transform image of an X-ray absorption fine structure of the CNZr₂-6 adsorbent, which showed that Zr—N and Zr—Cl coordination bonds existed simultaneously in the CNZr₂-6 adsorbent, that was, the zirconium atoms had a chlorine-nitrogen co-coordination structure.

An experiment of fluoride removal from water using the CNZr₁-6 adsorbent and the CNZr₂-6 adsorbent included the following steps: an F⁻ solution with an initial F⁻ concentration of 10 mg/L was formulated using sodium fluoride as a raw material, and adjusted to the pH of 3 using a dilute hydrochloric acid solution. 40 mL of the F⁻ solution was taken and added into a 50 mL plastic centrifuge tube, then added with each of the adsorbents at a dosage of 0.25 g/L, sonicated for 2 min to allow uniform dispersion of the adsorbent, and then shaken at a constant temperature of 25° C. and a rotation speed of 200 r/min for 48 h to allow the adsorption to reach equilibrium. An appropriate amount of the solution was taken and filtered with a 0.22 μm water-based polytetrafluoroethylene filter membrane. 10 mL of the filtrate was taken and placed into a 50 mL colorimetric tube, accurately added with 10 mL of a total ionic strength adjustment buffer (TISAB), diluted with pure water to the mark line, shaken uniformly, and poured into a 100 mL polyethylene beaker. The F⁻ concentration in the solution at equilibrium was analyzed and determined through a fluoride ion meter.

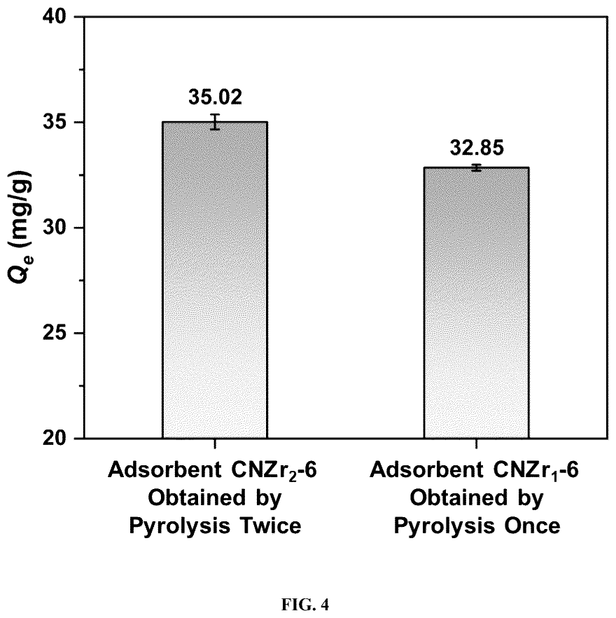

FIG. 4 was a comparison chart of the fluoride removal performances of the CNZr₁-6 adsorbent and the CNZr₂-6 adsorbent. It could be seen that secondary pyrolysis caused further delamination of the adsorbent, thereby exposing more adsorption sites, which could increase the F⁻ adsorption capacity from 32.85 mg/g to 35.02 mg/g.

### Comparative Example 1

2 g of melamine (MA) was mixed with 6 mmol of ZrCl₄ and ball-milled at a rotation speed of 550 r/min for 15 min. The resulting mixture was placed into a tube furnace, heated to 600° C. at a rate of 5° C./min under a nitrogen atmosphere and held at this temperature for 2 h to obtain a material from first pyrolysis. The material from the first pyrolysis was placed into a tube furnace, heated to 600° C. at a rate of 10° C./min under a nitrogen atmosphere and held at this temperature for 1 h to obtain a chlorine-nitrogen co-coordinated single-atom zirconium adsorbent (named as CNZr₂-6-MA) after second pyrolysis.

### Comparative Example 2

2 g of urea was mixed with 6 mmol of ZrCl₄ and ball-milled at a rotation speed of 550 r/min for 15 min. The resulting mixture was placed into a tube furnace, heated to 600° C. at a rate of 5° C./min under a nitrogen atmosphere and held at this temperature for 2 h to obtain a material from first pyrolysis. The material from the first pyrolysis was placed into a tube furnace, heated to 600° C. at a rate of 10° C./min under a nitrogen atmosphere and held at this temperature for 1 h to obtain a chlorine-nitrogen co-coordinated single-atom zirconium adsorbent (named as CNZr₂-6-Urea) after second pyrolysis.

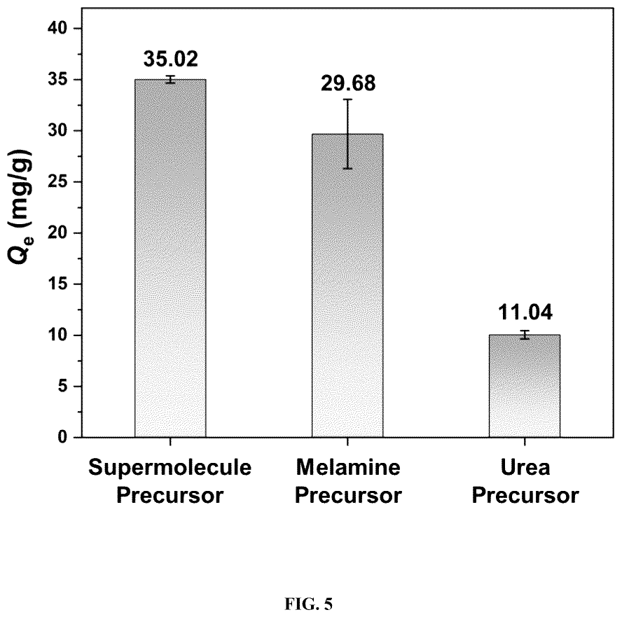

The adsorbents prepared in Comparative Examples 1 to 2 were respectively tested for the fluoride removal performance in water, with the same testing methods as that in Example 1. FIG. 5 is a comparison chart of the fluoride removal performances of adsorbents synthesized from three different carbon nitride precursors: CNZr₂-6, CNZr₂-6-MA and CNZr₂-6-Urea. It could be seen that the adsorbent CNZr₂-6 prepared with the supermolecule as the precursor had the optimum fluoride removal effect, with an adsorption capacity (Qₑ) of up to 35.02 mg/g. Therefore, the supermolecule was selected as the optimum precursor for preparing the fluoride removal adsorbent.

### Example 2

During preparation of the chlorine-nitrogen co-coordinated single-atom zirconium adsorbent, the usage amount of ZrCl₄ in the step 2) was changed from 6 mmol to 0, 2, 4, 8 or 10 mmol. The rest of the preparation method and parameters were the same as those in Example 1. The resulting adsorbents were denoted as CNZr₂-0, CNZr₂-2, CNZr₂-4, CNZr₂-8 and CNZr₂-10, respectively.

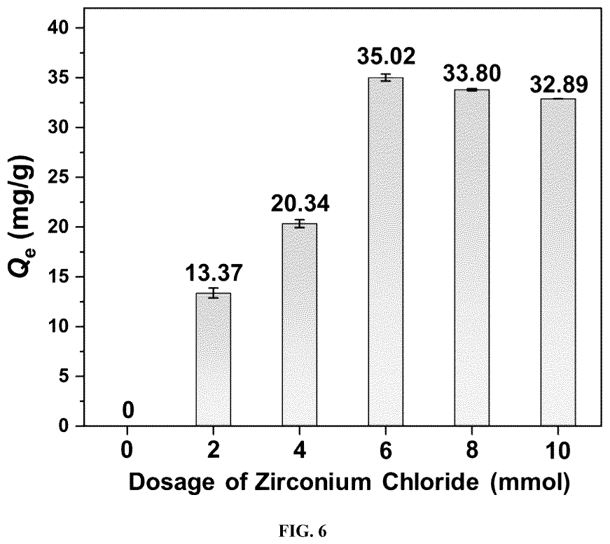

The adsorbents prepared in Example 2 were respectively tested for fluoride removal performances in water, with the same testing method as that in Example 1. FIG. 6 was a comparison chart of the fluoride removal performances of the synthesized adsorbents with different dosages of ZrCl₄. It could be seen that as the dosage of ZrCl₄ increased, the adsorption capacity of the obtained adsorbent for F⁻ first gradually increased, reaching a maximum of 35.02 mg/g when the dosage of ZrCl₄ was 6 mmol; and when the dosage of ZrCl₄ further increased, the fluoride removal performance of the resulting adsorbent began to gradually decrease. Furthermore, when the dosage of ZrCl₄ was 0, the adsorption capacity of the resulting adsorbent CNZr₂-0 for F⁻ was 0, and thus it could be seen that zirconium played a dominant role in fluoride removal.

CNZr₂-x (x=2, 4, 6, 8, 10) was digested by thermal digestion. Then, the zirconium content in the digestion solution was determined by inductively coupled plasma emission spectrometry. The mass fraction of zirconium in each adsorbent was calculated according to the measured results. The results were shown in details in Table 1.

TABLE 1
Mass fraction of zirconium in CNZr₂-x adsorbent

| Adsorbent | Mass fraction of zirconium (wt %) |
|---|---|
| CNZr₂-2 | 25.34 |
| CNZr₂-4 | 27.78 |
| CNZr₂-6 | 35.66 |
| CNZr₂-8 | 43.78 |
| CNZr₂-10 | 47.56 |

It could be seen from the results shown in Table 1 that, with the increase of the dosage of ZrCl₄, the mass fraction of zirconium in the resulting adsorbent also gradually increased. As shown in FIG. 6, when the dosage of ZrCl₄ was increased to 8 and 10 mmol, the fluoride removal performances of the resulting adsorbents decreased. This was because that when the mass fraction of zirconium was too high, the carbon nitride support could not provide enough nitrogen ligands to anchor all zirconium atoms, and some of the zirconium atoms began to aggregate to form ZrO₂ nanoparticles, thereby reducing the fluoride removal efficiency. Therefore, the optimal dosage of ZrCl₄ was 6 mmol, at which point the mass ratio of the supermolecule to ZrCl₄ was 1:0.70.

### Example 3

During preparation of the chlorine-nitrogen co-coordinated single-atom zirconium adsorbent, the pyrolysis temperature in the step 2) was changed from 600° C. to 500° C., 700° C. or 800° C., and the rest of the preparation method and parameters were the same as those in Example 1.

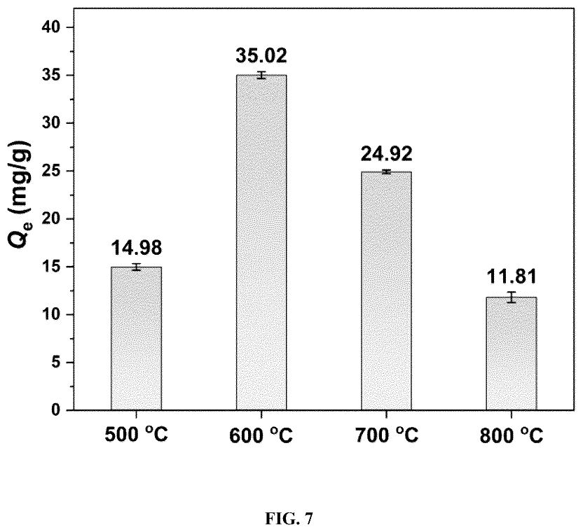

The adsorbents prepared in Example 3 were respectively tested for the fluoride removal performance in water, with the same testing method as that in Example 1. FIG. 7 was a comparison chart of the fluoride removal performances of adsorbents synthesized at different pyrolysis temperatures. It could be seen that as the pyrolysis temperature increased, the adsorption capacity of the resulting adsorbent for F⁻ first increased and then decreased, reaching a maximum value of 35.02 mg/g at 600° C. When the calcination temperature increased from 500° C. to 600° C., a large amount of gas was released from the supermolecule precursor, forming a high pressure among the carbon nitride layers to promote the delamination of the carbon nitride and acting as a pore-forming agent to create abundant pores on the carbon nitride nanosheets, thereby increasing the specific surface area of the adsorbent and improving the exposure of adsorption sites, thus significantly enhancing the fluoride removal performance. However, when the pyrolysis temperature continued to rise from 600° C. to 700° C. and 800° C., the zirconium atoms were driven by thermal energy to break free from the constraint of the carbon nitride support and bound with oxygen atoms in the supermolecule precursor, thereby migrating and aggregating to form ZrO₂ nanoparticles, which greatly reduced the fluoride removal capacity to 24.92 and 11.81 mg/g. Therefore, the optimal pyrolysis temperature for preparing the chlorine-nitrogen co-coordinated single-atom zirconium adsorbent was 600° C.

### Example 4

Five common inorganic salt anions in industrial wastewater were selected as coexisting interfering ions for F⁻, including SiO₃²⁻, PO₄³⁻, SO₄²⁻, NO₃⁻; and Cl®, and three adsorbent dosages (0.25 g/L, 0.35 g/L, and 0.50 g/L) were selected to further study the performance of the adsorbent CNZr₂-6 synthesized in Example 1 in removing low concentrations of F⁻ under the interference of high concentrations of inorganic salts. The specific operating steps were as follows: any one of sodium metasilicate nonahydrate, sodium dihydrogen phosphate, sodium sulfate, sodium nitrate, or sodium chloride, and sodium fluoride were used as raw materials to formulate a series of mixed solutions containing F⁻ and different concentrations of inorganic salt anions, with the F⁻ concentration being controlled at 10 mg/L, and the concentrations of coexisting inorganic salt anions being set to 0, 5, 10, 20, 50, and 100 mmol/L, respectively. The pH of the mixed solution was adjusted to 3 with a hydrochloric acid solution. 40 mL of the mixed solution was taken and added into a 50 mL plastic centrifuge tube, then added with the CNZr₂-6 adsorbent at dosages of 0.25 g/L, 0.35 g/L, or 0.50 g/L, sonicated for 2 min to allow uniform dispersion of the adsorbent, and then shaken at a constant temperature of 25° C. and a rotation speed of 200 r/min for 48 h to allow the adsorption to reach equilibrium. An appropriate amount of the solution was taken and filtered with a 0.22 μm water-based polytetrafluoroethylene filter membrane. 10 mL of the filtrate was taken and placed into a 50 mL colorimetric tube, accurately added with 10 mL of a total ionic strength adjustment buffer (TISAB), diluted with pure water to the mark line, shaken uniformly, and poured into a 100 mL polyethylene beaker. The F⁻ concentration in the solution at equilibrium was analyzed and determined through a fluoride ion meter.

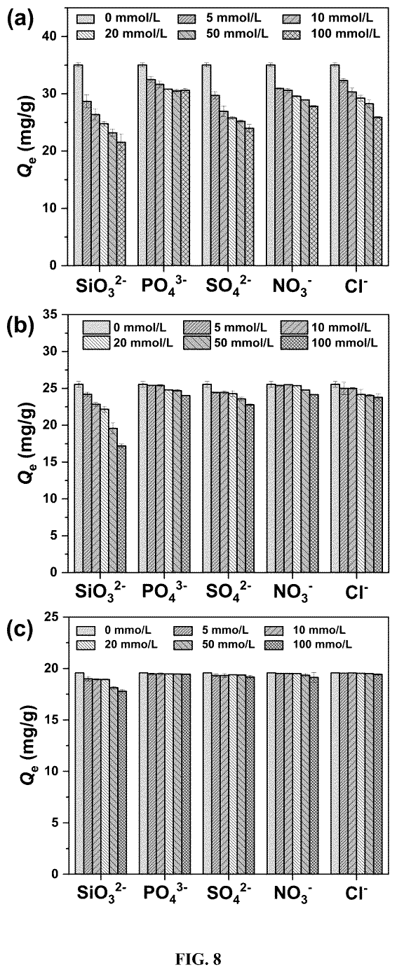

FIG. 8 was a diagram showing the effects of the CNZr₂-6 adsorbent in removing low concentrations of F⁻ under the coexistence of different types and concentrations of inorganic salt anions. When the adsorbent dosage was low (0.25 g/L), the high concentration of coexisting anions and the low concentration of F⁻ strongly competed for limited adsorption sites, resulting in a decrease in the fluoride removal capacity of CNZr₂-6 compared to that when no anion was co-existed. Increasing the dosage of the adsorbent could provide more adsorption sites, which was beneficial to improving the F⁻ removal rate under stress of high concentrations of inorganic salts. When the adsorbent dosage was increased to 0.50 g/L, even if the concentrations of the inorganic salt anions SiO₃²⁻, PO₄³⁻, SO₄²⁻, NO₃⁻; and Cl⁻ reached up to 100 mmol/L, which was 190 times the concentration of F″, the fluoride removal capacity of CNZr₂-6 decreased by only 9.15%, 0.66%, 2.04%, 2.25% and 0.77% respectively compared to those when no anion was co-existed, demonstrating excellent resistance to inorganic salt interference. Therefore, the CNZr₂-6 adsorbent was suitable for selective removal of low concentrations of F⁻ from a high-concentration inorganic salt solution.

### Comparative Example 3

The PAMD resin, D213 resin, and ZrO₂ nanoparticles were tested for fluoride removal performances, with the testing method differed from that in Example 1 in that the dosage of the adsorbent was 0.50 g/L. Moreover, the salt tolerance of these three adsorbents during fluoride removal was studied using sodium sulfate as a representative inorganic salt. The concentration of sodium sulfate coexisting with 10 mg/L of F⁻ was set to 0.05 mol/L.

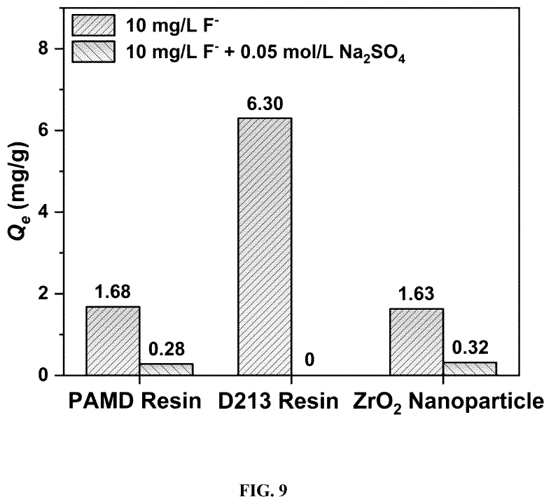

FIG. 9 was a comparison chart of fluoride removal performances of the PAMD resin, D213 resin, and ZrO₂ nanoparticles. It could be seen that at a dosage of 0.50 g/L, the adsorption capacities of the PAMD resin, D213 resin, and ZrO₂ nanoparticles for F⁻ were only 1.68, 6.30, and 1.63 mg/g, respectively, while under the same conditions, the adsorption capacity of the CNZr₂-6 adsorbent for F⁻ was 19.57 mg/g, which was 11.65 times, 3.11 times, and 12.01 times those of the PAMD resin, D213 resin, and ZrO₂ nanoparticles, respectively. More crucially, under the interference of 0.05 mol/L sodium sulfate, the fluoride removal capacities of the PAMD resin, D213 resin and ZrO₂ nanoparticles decreased to 0.28, 0 and 0.32 mg/g, respectively, and their salt tolerance was significantly weaker than that of CNZr₂-6.

### APPLICATION EXAMPLES

To investigate the performance of the chlorine-nitrogen co-coordinated single-atom zirconium adsorbent in treating actual high-salinity fluorine-containing wastewater, the production wastewater from a photovoltaic enterprise in Changzhou, Jiangsu Province was selected for the experiment. The water quality of the wastewater was shown in Table 2 below.

TABLE 2
Water quality of production wastewater from a photovoltaic
enterprise in Changzhou, Jiangsu Province

| | Water quality | | Numerical value or |
|---|---|---|---|
| Serial Number | indicators | Unit | Concentration |
| 1 | pH | / | 6.2 |
| 2 | F⁻ | mg/L | 9.65 |
| 3 | Cl⁻ | mg/L | 480 |
| 4 | SO₄²⁻ | mg/L | 152 |
| 5 | SiO₃²⁻ | mg/L | 0.36 |
| 6 | NO₃⁻ | mg/L | 28.9 |
| 7 | Ca²⁺ | mg/L | 167 |
| 8 | Mg²⁺ | mg/L | 8.8 |
| 9 | Al³⁺ | mg/L | 0.096 |

A fluoride removal experiment was conducted using the CNZr₂-6 adsorbent synthesized in Example 1, including the following steps: the pH of the aforementioned fluoride-containing industrial wastewater was adjusted to 3 using a hydrochloric acid solution. Then, 40 mL of the wastewater was taken and added into a 50 mL plastic centrifuge tube, then added with the adsorbent at a dosage of 0.50 g/L, sonicated for 2 min to allow uniform dispersion of the adsorbent, and then shaken at a constant temperature of 25° C. and a rotation speed of 200 r/min for 48 h to allow the adsorption to reach equilibrium. An appropriate amount of the solution was taken and filtered with a 0.22 μm water-based polytetrafluoroethylene filter membrane. 10 mL of the filtrate was taken and placed into a 50 mL colorimetric tube, accurately added with 10 mL of a total ionic strength adjustment buffer (TISAB), diluted with pure water to the mark line, shaken uniformly, and poured into a 100 mL polyethylene beaker. The F⁻ concentration in the solution at equilibrium was analyzed and determined through a fluoride ion meter. The experimental results showed that 95.27% of F⁻ in the industrial wastewater was removed, which showed the excellent performance of the chlorine-nitrogen co-coordinated single-atom zirconium adsorbent in treating actual high-salinity fluorine-containing wastewater.

The above description is only preferred embodiments of the present disclosure. It should be pointed out that, for those of ordinary skills in the art, several improvements and modifications can be made without departing from the principle of the present disclosure. These improvements and modifications should also be considered as falling into the claimed scope of the present disclosure.

What is claimed is:

1. A method for preparing a chlorine-nitrogen co-coordinated single-atom zirconium adsorbent, comprising the following steps:
1) dissolving melamine and cyanuric acid respectively in hot water, mixing the two resulting solutions, then continually heating and stirring to carry out a self-assembly reaction, filtering by suction and oven-drying to obtain a supermolecule; and
2) ball-milling the supermolecule obtained in the step 1) with zirconium chloride under mixing, placing the resulting mixed powder into a tube furnace and subjecting to first pyrolysis under protection with an inert gas, cooling, then placing the resulting powder into the tube furnace again and subjecting to second pyrolysis under protection with an inert gas to obtain the chlorine-nitrogen co-coordinated single-atom zirconium adsorbent, wherein a mass ratio of the supermolecule to the zirconium chloride is 1:0.2-1:1.2, a temperature for the first pyrolysis is 500-800° C., and a temperature for the second pyrolysis is 500-800° C.

2. The method for preparing a chlorine-nitrogen co-coordinated single-atom zirconium adsorbent according to claim 1, wherein: in the step 1), a molar ratio of melamine to cyanuric acid is 1:1; a concentration of a melamine or cyanuric acid solution is 0.1-5 mol/L; a temperature of the hot water for dissolving melamine or cyanuric acid is 80-100° C.; a heating temperature when the self-assembly is performed after the melamine solution and the cyanuric acid solution are mixed is 80-100° C., and a time for the stirring is 1-4 h.

3. The method for preparing a chlorine-nitrogen co-coordinated single-atom zirconium adsorbent according to claim 1, wherein: in the step 2), a rotation speed for ball milling the supermolecule with zirconium chloride under stirring is 400-800 r/min, and a time for the ball milling is 10-60 min.

4. The method for preparing a chlorine-nitrogen co-coordinated single-atom zirconium adsorbent according to claim 1, wherein: in the step 2), during the first pyrolysis, a protecting gas is nitrogen or argon, a heating rate is 1-10° C./min, and a pyrolysis time is 1-4 h.

5. The method for preparing a chlorine-nitrogen co-coordinated single-atom zirconium adsorbent according to claim 1, wherein: in the step 2), during the second pyrolysis, a protecting gas is nitrogen or argon, a heating rate is 5-10° C./min, and a pyrolysis time is 1-2 h.

6. A chlorine-nitrogen co-coordinated single-atom zirconium adsorbent prepared by the method for preparing a chlorine-nitrogen co-coordinated single-atom zirconium adsorbent according to claim 1.

7. Use of the chlorine-nitrogen co-coordinated single-atom zirconium adsorbent according to claim 6 in the removal of low concentrations of fluoride ions in high-salinity wastewater.

8. The use of the chlorine-nitrogen co-coordinated single-atom zirconium adsorbent according to claim 7 in the removal of low concentrations of fluoride ions in high-salinity wastewater, wherein: a concentration of the fluoride ions is not higher than 10 mg/L.

9. The use of the chlorine-nitrogen co-coordinated single-atom zirconium adsorbent according to claim 8 in the removal of low concentrations of fluoride ions in high-salinity wastewater, wherein: a dosage of the adsorbent in the wastewater is 0.25-0.50 g/L.
